(19) United States
(12) Patent Application Publication
(10) Pub. No.: US 2013/0268556 A1
(43) Pub. Date: Oct. 10, 2013

(54) SYSTEM AND METHOD FOR RECORDING AND QUERYING ORIGINAL HANDWRITING AND ELECTRONIC DEVICE

(71) Applicants: Shuqing Han, Beijing (CN); Jia Zhou, Beijing (CN); Guoving Du, Beijing (CN)

(72) Inventors: Shuqing Han, Beijing (CN); Jia Zhou, Beijing (CN); Guoving Du, Beijing (CN)

(73) Assignee: BEIJING ERENEBEN INFORMATION TECHNOLOGY CO., LTD., Beijing (CN)

(21) Appl. No.: 13/994,734

(22) PCT Filed: Dec. 15, 2011
(86) PCT No.: PCT/CN2011/002107

§ 371 Date: Jun. 15, 2013

(30) Foreign Application Priority Data
Dec. 15, 2010 (CN) 201010589958.0

(51) Int. Cl. G06F 17/30

(52) U.S. Cl. CPC G06F 17/30424
USPC 707/769

(57) ABSTRACT

Disclosed are a system and method for recording and querying an original handwriting trace and an electronic device. The system comprises: an input module for inputting record information and query information; a matching module for obtaining title information consisting of standard characters matching with inputted title information of original handwriting trace, and storing content information of original handwriting trace corresponding to the title information consisting of standard characters; a storage module, comprising a storage area for title information consisting of standard characters and a storage area for content information of original handwriting trace; a query module for querying title information consisting of standard characters according to the inputted query information, and obtaining content information of original handwriting trace corresponding to the title information consisting of standard characters; a display module for displaying content information of original handwriting trace; and a main control module for coordinating and controlling the above modules.

### TECHNICAL FIELD

The present invention relates to information inputting and querying technologies of an electronic device.

### TECHNICAL BACKGROUND

With the development of computer technologies, tablet Personal Computers (tablet PCs) have emerged in the market and become the accompanying equipments for business people. The tablet PC can meet various needs, such as working, learning and entertainment, for business people anywhere and anytime due to its small size and good portability. Further, the tablet PC supports multi-task operations and a great number of application software, and thus can comprehensively meet needs for mobile office.

Information is generally inputted into the existing electronic device, especially the tablet PC, through a keyboard or a touch screen, and ultimately presented to the user as standard characters printed by the computer, but functions of inputting (or storing) and displaying an original handwriting trace are not achieved. As a result, the functions of inputting (or storing) and querying the original handwriting trace cannot be achieved in an application system of the tablet PC, especially in a notepad application.

### SUMMARY OF THE INVENTION

In view of the drawbacks of the prior art, an object of the invention is to provide a better user experience for the notepad application of the electronic devices such as the tablet PC.

To this end, the present invention proposes a system for recording and querying an original handwriting trace, and the system includes:

an input module, configured for inputting record information and query information;

a matching module, configured for obtaining title information consisting of standard characters matching with inputted title information of original handwriting trace, and storing content information of original handwriting trace corresponding to the title information consisting of standard characters;

a storage module comprising: a storage area for title information consisting of standard characters, which is used for storing the title information consisting of recognized standard characters; and a storage area for content information of original handwriting trace, which is used for storing content of original handwriting trace of the content information corresponding to the title information consisting of standard characters;

a query module, configured for querying the title information consisting of standard characters based on the inputted query information by means of matching, and acquiring the content information of original handwriting trace corresponding to the title information consisting of standard characters based on the title information consisting of standard characters;

a display module, configured for displaying the content information of original handwriting trace; and

a control module, configured for coordinating and controlling the input module, the matching module, the display module, the query module and the storage module.

In the above system for recording and querying the original handwriting trace, the storage module further includes a storage area for content information consisting of standard characters, which is used for storing content information consisting of recognized standard characters; and the matching module is further used to recognize the content information of original handwriting trace corresponding to the title information consisting of standard characters as the content information consisting of standard characters, which is stored in the storage area for content information consisting of standard characters.

In the above system for recording and querying the original handwriting trace, the input module includes: a title input area for inputting a title; a content input area for inputting the content information corresponding to the inputted title; and a search input area for inputting a query keyword.

In the above system for recording and querying the original handwriting trace, after the keyword of the query information is inputted, the query module obtains a record entry containing the title information including the keyword by means of matching, for selectively invoking of the record entry.

In the above system for recording and querying the original handwriting trace, after the keyword of the query information is inputted, the query module obtains a record entry containing the content information including the keyword by means of matching, for the selectively invoking of the record entry.

In the above system for recording and querying the original handwriting trace, after the keyword of the query information is inputted, the query module obtains a record entry containing the title information including the keyword by means of matching, and obtains a record entry containing the content information including the keyword by means of matching, for the selectively invoking of the record entries.

In the above system for recording and querying the original handwriting trace, the record entries are sorted and displayed as per the time when the record entries are respectively recorded.

In the above system for recording and querying the original handwriting trace, the record entries are sorted and displayed as per priorities of the record entries preset by the user.

In the above system for recording and querying the original handwriting trace, the record entries are sorted and displayed as per the degree of matching with the keyword.

The present invention also proposes an electronic device with the above system for recording and querying the original handwriting trace.

The device includes a system for recording and querying an original handwriting trace, and the system includes:

an input module, configured for inputting record information and query information;

a matching module, configured for obtaining title information consisting of standard characters matching with inputted title information of original handwriting trace, and storing content information of original handwriting trace corresponding to the title information consisting of standard characters;

a storage module comprising: a storage area for title information consisting of standard characters, which is used for storing the title information consisting of recognized standard characters; and a storage area for content information of original handwriting trace, which is used for storing content of original handwriting trace of the content information corresponding to the title information consisting of standard characters;

a query module, configured for querying the title information consisting of standard characters based on the inputted query information by means of matching, and acquiring the content information of original handwriting trace corresponding to the title information consisting of standard characters based on the title information;

a display module, configured for displaying the content information of original handwriting trace; and

a control module, configured for coordinating and controlling the input module, the matching module, the display module, the query module and the storage module.

The present invention also provides a method for recording and querying an original handwriting trace, and the method includes steps of:

S1: inputting the information of an original handwriting trace by handwriting;

S2: conducting the matching of the inputted information of original handwriting trace to obtain standard character information corresponding to the information of original handwriting trace, and establishing and storing an association relationship between the information of original handwriting trace and the matching standard character information;

S3: inputting query information to query the standard character information by means of matching, to obtain and output the information of original handwriting trace corresponding to the query information.

The information of original handwriting trace includes the title information of original handwriting trace and the content information of original handwriting trace corresponding to the title information of original handwriting trace.

The step S1 includes steps of:

S1-1: inputting the title information of original handwriting trace by handwriting; and

S1-2: inputting the content information of original handwriting trace corresponding to the title information of original handwriting trace by handwriting.

The step S2 includes steps of:

S2-1: recognizing the inputted title information of original handwriting trace by means of matching, to obtain and store title information consisting of standard characters corresponding to the title information of original handwriting trace; and

S2-2: associating the inputted content information of original handwriting trace with the title information consisting of standard characters by means of matching, to establish an association relationship therebetween.

The step S3 includes steps of:

S3-1: inputting the query information consisting of standard characters, or, inputting the query information of original handwriting trace by handwriting and recognizing the corresponding query information consisting of standard characters corresponding to the query information of original handwriting trace by means of matching; and

S3-2: based on the query information consisting of standard characters of the step S3-1, querying title information consisting of standard characters by means of matching, to obtain the title information consisting of standard characters matching with the query information consisting of standard characters, thereby obtaining the content information associated with the title information consisting of standard characters.

The step S2 further includes a step S2-3 including recognizing the inputted content information of original handwriting trace by means of matching to obtain content information consisting of standard characters corresponding to the content information of original handwriting trace, establishing and storing an association relationship between the content information consisting of standard characters and the content information of original handwriting trace.

The step S3 further includes a step S3-3 including: based on the query information consisting of standard characters of the step S3-1, querying content information consisting of standard characters by means of matching, to obtain the content information consisting of standard characters matching with the query information consisting of standard characters, thus obtaining the content information of original handwriting trace associated with the title information consisting of standard characters.

The present invention also provides a system for recording and querying an original handwriting trace, which includes:

an input module, configured for inputting information of original handwriting trace and query information;

a matching module, configured for recognizing the inputted information of original handwriting trace as standard character information by means of matching, and establishing an association relationship between the information of original handwriting trace and the standard character information;

a storage module, configured for storing the information of original handwriting trace and the standard character information associated with the information of original handwriting trace;

a query module, configured for querying the standard character information by means of matching based on the inputted query information, to obtain the information of original handwriting trace matching with the query information;

a display module, configured for displaying the information of original handwriting trace obtained from the query module; and

a control module, configured for coordinating and controlling the input module, the matching module, the display module, the query module and the storage module.

Through the inventive system for recording and querying the original handwriting trace, the functions for recording and querying the original handwriting trace are implemented. It is possible for the user to directly input original handwriting trace for querying and obtain the content displayed as the original handwriting trace. For example, if the user inputs a word of sea by handwriting, all contents with a title including the word of sea will be searched out immediately, thereby achieving the query function through the inputted original handwriting trace, to facilitate the use by the user, and improve user experience.

Further, the present invention enables the recognition and query of the inputted content, and the content of original handwriting trace will be presented to the user. If a plurality of record entries meeting the requirement are found, the plurality of record entries can be displayed according to, for example, the recording time, the priority, and the degree matching with the keyword, etc., which improves the convenience of the user.

### DESCRIPTION OF DRAWINGS

FIG. 1 is a schematic block diagram of the structure of a first embodiment of the present invention.

FIG. 2 is a schematic block diagram of an input module of the first embodiment of the present invention.

FIG. 3 is a schematic block diagram of the structure of a second embodiment of the present invention.

### DETAILED DESCRIPTION OF THE PREFERRED EMBODIMENT

The present invention will be described in further details with following specific embodiments in conjunction with the accompanying drawings.

### A First Embodiment

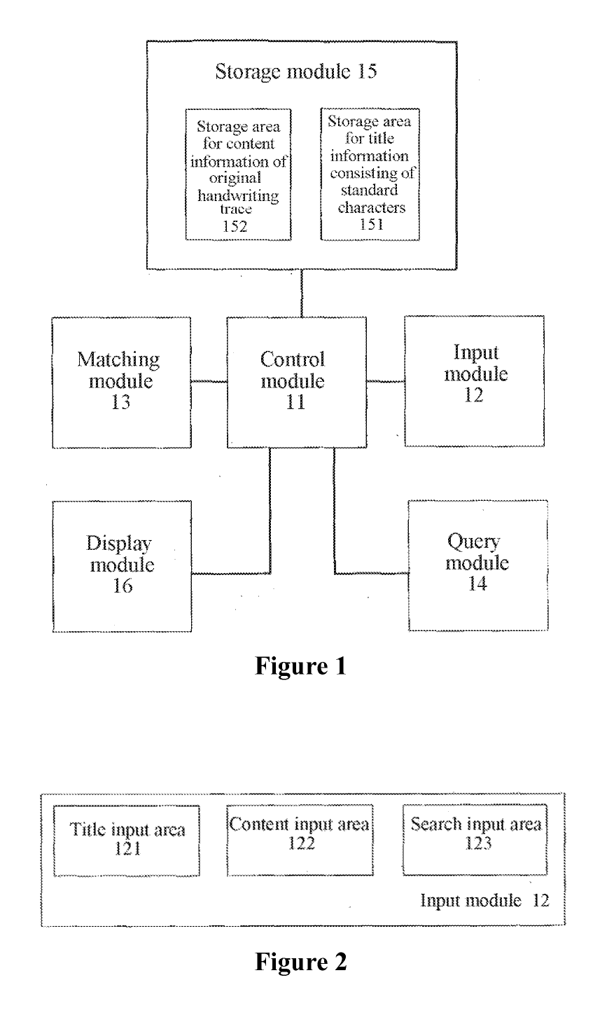

The electronic device in the first embodiment is illustrated, for example, as a tablet PC with a system for recording and querying an original handwriting trace. As shown in FIG. 1, the system includes a control module 11, an input module 12, a matching module 13, a query module 14, a storage module 15 and a display module 16, where the storage module 15 includes a storage area for title information consisting of standard characters 151 and a storage area for content information of original handwriting trace 152.

The input module 12, functioning as a main Human-Machine Interface, is configured to input the information of original handwriting trace, and is divided into a title input area 121, a content input area 122 and a search input area 123, where the title input area 121 is configured to input the title information of original handwriting trace, the content input area 122 is configured to input the content information of original handwriting trace corresponding to the title information of original handwriting trace, and the search input area 123 is configured to input the user's search keyword of original handwriting trace.

During the information processing by the tablet PC, the following steps are conducted under the coordination and control by the control module 11.

At a step of recording the inputted information by the input module 12, the information of original handwriting trace is inputted by a handwriting pen (such as an electromagnetic pen), for example, the title information is inputted by handwriting in the title input area 121, and the content information corresponding to the title information is inputted by handwriting in the content input area 122.

At a step of information storing and matching by the matching module 13, the matching of the inputted information of original handwriting trace is conducted to obtain standard character information corresponding to the information of original handwriting trace, and an association relationship between the information of original handwriting trace and matching standard character information is established and stored. In this embodiment, the inputted title information is recognized, the recognized title information is matched with standard characters previously stored in the character library of the tablet PC, and standard character(s) selected by means of matching is recorded and stored in the storage area for title information consisting of standard characters 151; and the corresponding content information of original handwriting trace is stored in the storage area for content information of original handwriting trace 152 as original handwriting traces in the form of Scalable Vector Graphics (SVG). As such, the title information can be mapped with the content information of original handwriting trace through the standard character(s).

At a step of information querying by the query module 14, query information is inputted for querying the standard character information by means of matching, in order to obtain and output the information of original handwriting trace corresponding to the query information. In this embodiment, a search keyword is inputted by handwriting in the search input area 123 through a handwriting pen (such as an electromagnetic pen). The inputted keyword is recognized, and the standard character corresponding to the keyword is obtained by means of matching. It is also possible to directly input the query information consisting of standard characters through the keyboard and the like, and the standard character of the corresponding title information can be found through the standard character of the keyword, thereby finally obtaining the content of original handwriting trace of the associated content information.

At a step of displaying the content of original handwriting trace by the display module 16, the title information and the content information matching with the title information is invoked and represented in the form of the original handwriting trace.

In the above steps, the user inputs the title information of original handwriting trace for searching by handwriting, and the content information searched out is the representation of the content of original handwriting trace previously inputted by handwriting, as if the user checks and reads the real paper-made notebook.

### A Second Embodiment

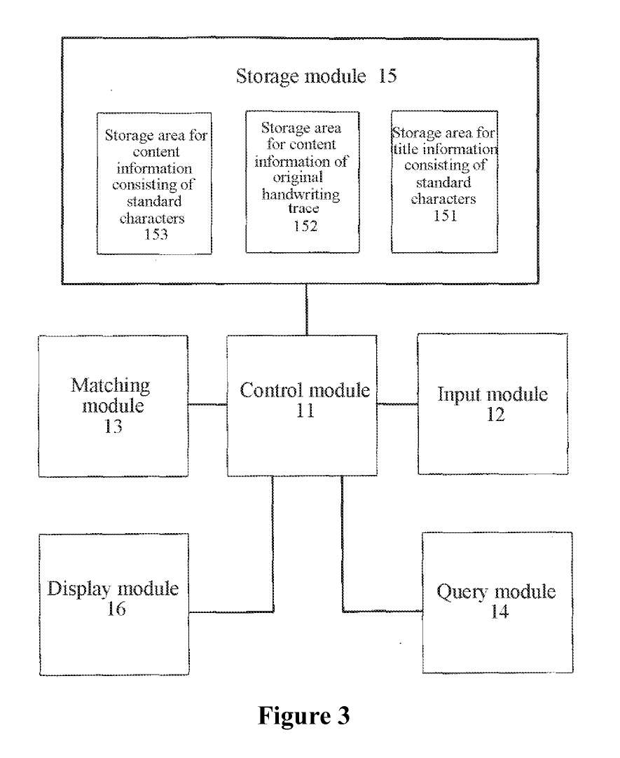

As shown in FIG. 3, the difference of the second embodiment from the first embodiment lies mainly in that the storage module 15 further includes a storage area for content information consisting of standard characters 153, which is configured to store the recognized standard characters of the content information in the second embodiment.

In this embodiment, the matching module 13 is used to recognize the title information as standard character(s); and the corresponding content information is also recognized as standard character(s) to be stored in the storage area for content information consisting of standard characters 153; further, the corresponding content information is also stored in the storage area for content information of original handwriting trace 152 as the original handwriting trace in the form of SVG.

In the step of information querying, after the keyword is inputted, the query module 14 is used to obtain, by means of matching, a record entry of which the title information and/or content information includes the keyword, and the obtained record entries are sorted according to a sort mode preset by the user. In the present embodiment, the record entries may be displayed on the display module 16 in the form of a list, for the sake of reviewing by the user. When the user selects a certain record entry, the record of the original handwriting trace of the content information matching with the record entry is invoked and displayed directly.

The sort mode preset by the user includes: a sort mode as per the time when the record entry is recorded by the user, a sort mode as per the priority preset, etc. However, the present invention is not limited thereto.

Further, when the user does not preset the sort mode, the record entries are sorted by default based on the degree of matching with the keyword. The record entry including the title information of original handwriting trace with the highest degree of matching with the keyword is selected firstly, and then the record entry including the title information of original handwriting trace with the secondary highest degree of matching with the keyword is selected, and so on. If the keyword is not contained in the title information of original handwriting trace, the record entry including the content information of original handwriting trace with the highest degree of matching with the keyword is selected, and then the record entry including the content information of original handwriting trace with the secondary highest degree of matching with the keyword is selected, and so on. For selecting the record entry including the content information of original handwriting trace with the highest degree of matching with the keyword, the assessment of the matching degree is based on the number of occurrences of the keyword in the content information of original handwriting trace.

### A Third Embodiment

In this embodiment, the input module (i.e. the Human-Machine Interface) of the tablet PC is divided into a title input area, a content input area and a search input area. Both the title input area and the content input area may be displayed for inputting the record, and the search input area may be displayed when the query function is invoked.

In the above embodiments, the keyword can be a character, a word, a phrase, a plurality of characters, a plurality of words, and so on.

The above description is detailed illustration of the present invention in combination with the specific preferred embodiments. However, the implementation of the present invention is not intended to limit the present invention in any form. Those skilled in the art can make deductions and replacements, which are considered to be within the scope of the patent protection determined by the appended claims without departing from the conception of the present invention. For example, in the step of querying, after the keyword of the query information is inputted, the query module can obtain the record entry including the title information containing the keyword, as well as the record entry including the content information containing the keyword, by means of matching, and list both the record entries for selectively invoking by the user.

1. A system for recording and querying an original handwriting trace, comprising:
an input module, configured for inputting record information and query information;
a matching module, configured for obtaining title information consisting of standard characters matching with inputted title information of original handwriting trace, and storing content information of original handwriting trace corresponding to the title information consisting of standard characters;
a storage module comprising: a storage area for title information consisting of standard characters, which is used for storing the title information consisting of recognized standard characters; and a storage area for content information of original handwriting trace, which is used for storing content of original handwriting trace of the content information corresponding to the title information consisting of standard characters;
a query module, configured for querying the title information consisting of standard characters based on the inputted query information by means of matching, and acquiring the content information of original handwriting trace corresponding to the title information consisting of standard characters based on the title information consisting of standard characters;
a display module, configured for displaying the content information of original handwriting trace; and
a control module, configured for coordinating and controlling the input module, the matching module, the display module, the query module and the storage module.

2. The system of claim 1, wherein, the storage module further includes a storage area for content information consisting of standard characters, which is used for storing content information consisting of recognized standard characters; and the matching module is further used to recognize the content information of original handwriting trace corresponding to the title information consisting of standard characters as the content information consisting of standard characters, which is stored in the storage area for content information consisting of standard characters.

3. The system of claim 1, wherein, the input module comprises: a title input area for inputting a title; a content input area for inputting content information corresponding to the title; and a search input area for inputting a query keyword.

4. The system of claim 1, wherein, after a keyword of the query information is inputted, the query module obtains a record entry containing the title information including the keyword by means of matching, for the selectively invoking of the record entry.

5. The system of claim 2, wherein, after a keyword of the query information is inputted, the query module obtains a record entry containing the content information including the keyword by means of matching, for the selectively invoking of the record entry.

6. The system of claim 2, wherein, after a keyword of the query information is inputted, the query module obtains a record entry containing the title information including the keyword by means of matching, and obtains a record entry containing the content information including the keyword by means of matching, for the selectively invoking of the record entries.

7. The system of claim 4, wherein, the record entries are sorted and displayed as per the time when the record entries are respectively recorded; or the record entries are sorted and displayed as per the priorities preset by the user; or the record entries are sorted and displayed as per the degree of matching with the keyword.

8. An electronic device with the system for recording and querying an original handwriting trace according to claim 1.

9. A method for recording and querying an original handwriting trace, comprising steps of:
S1: inputting information of original handwriting trace by handwriting;
S2: conducting the matching of the inputted information of original handwriting trace to obtain standard character information corresponding to the information of original handwriting trace, and establishing and storing an association relationship between the information of original handwriting trace and the matching standard character information; and
S3: inputting query information to query the standard character information by means of matching, to obtain and output the information of original handwriting trace corresponding to the query information.

10. The method of claim 9, wherein, the information of original handwriting trace includes title information of original handwriting trace and content information of original handwriting trace corresponding to the title information of original handwriting trace;
the step S1 comprises steps of:
S1-1: inputting the title information of original handwriting trace by handwriting; and
S1-2: inputting the content information of original handwriting trace corresponding to the title information of original handwriting trace by handwriting;
the step S2 comprises steps of:
S2-1: recognizing the inputted title information of original handwriting trace by means of matching, to obtain and store title information consisting of standard characters corresponding to the title information of original handwriting trace; and
S2-2: associating the inputted content information of original handwriting trace with the title information consisting of standard characters by means of matching, to establish an association relationship therebetween;
the step S3 comprises steps of:
S3-1: inputting the query information consisting of standard characters, or, inputting the query information of original handwriting trace by handwriting and recognizing the query information consisting of standard characters corresponding to the query information of original handwriting trace by means of matching; and
S3-2: based on the query information consisting of standard characters of the step S3-1, querying title information consisting of standard characters by means of matching, to obtain the title information consisting of standard characters matching with the query information consisting of standard characters, thereby obtaining the content information of original handwriting trace associated with the title information consisting of standard characters.

11. The method of claim 10, wherein, the step S2 further comprises a step S2-3 including: recognizing the inputted content information of original handwriting trace by means of matching to obtain content information consisting of standard characters corresponding to the content information of original handwriting trace, and establishing and storing an association relationship between the content information consisting of standard characters and the content information of original handwriting trace.
the step S3 further comprises a step S3-3 including: based on the query information consisting of standard characters of the step S3-1, querying content information consisting of standard characters by means of matching, to obtain the content information consisting of standard characters matching with the query information consisting of standard characters, thus obtaining the content information of original handwriting trace associated with the title information consisting of standard characters.

12. A system for recording and querying an original handwriting trace, comprising:
an input module, configured for inputting information of original handwriting trace and query information;
a matching module, configured for recognizing the inputted information of original handwriting trace as standard character information by means of matching, and establishing an association relationship between the information of original handwriting trace and the standard character information;
a storage module, configured for storing the information of original handwriting trace and the standard character information associated with the information of original handwriting trace;
a query module, configured for querying the standard character information by means of matching based on the inputted query information, to obtain the information of original handwriting trace matching with the query information;
a display module, configured for displaying the information of original handwriting trace obtained by the query module; and
a control module, configured for coordinating and controlling the input module, the matching module, the display module, the query module and the storage module.

13. The system of claim 5, wherein, the record entries are sorted and displayed as per the time when the record entries are respectively recorded; or the record entries are sorted and displayed as per the priorities preset by the user; or the record entries are sorted and displayed as per the degree of matching with the keyword.

14. The system of claim 6, wherein, the record entries are sorted and displayed as per the time when the record entries are respectively recorded; or the record entries are sorted and displayed as per the priorities preset by the user; or the record entries are sorted and displayed as per the degree of matching with the keyword.
